(19) United States
(12) Patent Application Publication
(10) Pub. No.: US 2026/0266757 A1
(43) Pub. Date: Sep. 10, 2026

(54) GAS SENSOR, CONTROL DEVICE AND CONTROL METHOD FOR GAS SENSOR

(71) Applicant: NGK INSULATORS, LTD., Nagoya-shi (JP)

(72) Inventor: Kousuke UJIHARA, Obu-shi (JP)

(21) Appl. No.: 19/557,806

(22) Filed: Mar. 5, 2026

(30) Foreign Application Priority Data
Mar. 7, 2025 (JP) 2025-036295

(51) Int. Cl. G01N 27/406

(52) U.S. Cl. CPC G01N 27/4067; G01N 27/4065

(57) ABSTRACT

A gas sensor includes a sensor element having an element body and a heating portion provided inside the element body, and a control device configured to control a voltage applied to the heating portion. When heating the element body, the control device performs warm-up control processing for controlling the voltage applied to the heating portion such that, when the degree of degradation of the heating portion is equal to or greater than a predetermined degree, a rate of change per unit time of a resistance ratio becomes smaller than when the degree of degradation is less than the predetermined degree.

### CROSS-REFERENCE TO RELATED APPLICATION

The present application claims priority from Japanese Patent Application No. 2025-036295 filed Mar. 7, 2025, the entire contents of which are incorporated herein by reference.

### BACKGROUND OF THE INVENTION

### 1. Field of the Invention

The present invention relates to a gas sensor, a control device, and a control method for the gas sensor.

### 2. Description of the Related Art

Conventionally, gas sensors configured to detect the concentration of a specific gas such as NOx in a measurement gas such as exhaust gas from an internal combustion engine have been known (for example, see Patent Literature 1). The gas sensor disclosed in PTL 1 includes a sensor element having an element body and a resistive heating element provided inside the element body.

### CITATION LIST

### Patent Literature

PTL 1: JP 2017-041419 A

### SUMMARY OF THE INVENTION

In the above-described gas sensor, depending on the degree of deterioration of the resistive heating element, the amount of heat generated by energizing the resistive heating element may locally increase during heating of the element body, resulting in a steep temperature gradient within the element body, and possibly causing damage such as cracks in the element body.

A main object of the gas sensor, the control device, and the control method for the gas sensor according to the present invention is to suppress the occurrence of damage to the element body during heating of the element body.

In order to achieve the above-described main object, the gas sensor, the control device, and the control method for the gas sensor according to the present invention employ the following configuration.
[1] The gas sensor according to the present invention is a gas sensor comprising: a sensor element including an element body and a resistive heating element provided inside the element body; and a control device configured to control a voltage applied to the resistive heating element, the gas sensor being configured to detect a concentration of a specific gas in a measurement gas, wherein the control device is configured to perform heating control processing for controlling the voltage applied to the resistive heating element such that, when a degree of degradation of the resistive heating element is equal to or greater than a predetermined degree, a rate of change per unit time of a resistance-related value related to a resistance value of the resistive heating element is smaller than that when the degree of degradation is less than the predetermined degree, during heating of the element body.

In the gas sensor according to the present invention, the control device performs the heating control processing for controlling the voltage applied to the resistive heating element such that, when the degree of degradation of the resistive heating element is equal to or greater than the predetermined degree, the rate of change per unit time of the resistance-related value related to the resistance value of the resistive heating element is smaller than that when the degree of degradation is less than the predetermined degree, during heating of the element body. When the degree of degradation of the resistive heating element is equal to or greater than the predetermined degree, during heating of the element body by energizing the resistive heating element, the amount of heat generated at a deteriorated portion of the resistive heating element tends to locally increase, making a temperature gradient within the element body steeper than when the degree of degradation is less than the predetermined degree. In view of this, by performing the heating control processing as described above, it is possible to suppress the temperature gradient within the element body from becoming steep during heating of the element body, thereby suppressing the occurrence of damage such as cracks in the element body.
[2] In the gas sensor described above (the gas sensor according to item [1]), the resistance-related value may be selected from the group consisting of: a resistance ratio obtained by dividing a current-temperature resistance value, which is a resistance value of the resistive heating element at a current temperature of the sensor element, by a reference-temperature resistance value, which is a resistance value of the resistive heating element at a reference temperature; a temperature of the element body; a temperature of any one of a plurality of electrodes provided on the element body; or an impedance between any two of the plurality of electrodes. It is also possible to estimate the temperature of an electrode based on an impedance between any two of the electrodes.
[3] In the gas sensor described above (the gas sensor according to item [2]), the control device, during heating of the element body, may be configured to set a target heating curve such that, when the degree of degradation is equal to or greater than the predetermined degree, the target heating curve increases more gradually than when the degree of degradation is less than the predetermined degree, and may be configured to control the voltage applied to the resistive heating element such that the resistance ratio increases along the target heating curve.
[4] In the gas sensor described above (the gas sensor according to item [2]), the control device, during heating of the element body, may be configured to set a target resistance ratio for each time point such that, when the degree of degradation is equal to or greater than the predetermined degree, the target resistance ratio increases more gradually than when the degree of degradation is less than the predetermined degree, and may be configured to control the voltage applied to the resistive heating element such that the resistance ratio increases along the target resistance ratio.
[5] In the gas sensor described above (any one of the gas sensors according to any one of items [1] to [4]), the degree of degradation may be either a resistance increase ratio obtained by dividing a reference-temperature resistance value, which is a resistance value of the resistive heating element at a reference temperature for a current sensor element, by a reference-temperature resistance value for an initial sensor element, or a resistance increase amount obtained by subtracting the reference-temperature resistance value for the initial sensor element from the current reference-temperature resistance value for the current sensor element. The control device may be configured to determine that the degree of degradation is equal to or greater than the predetermined degree when the resistance increase ratio is equal to or greater than a predetermined increase ratio, or when the resistance increase amount is equal to or greater than a predetermined increase amount.
[6] In the gas sensor described above (the gas sensor according to item [5]), the control device, before starting the heating control processing, may be configured to estimate the current reference-temperature resistance value of the resistive heating element for the current sensor element based on a resistance value and a temperature of the resistive heating element.
[7] In the gas sensor described above (any one of the gas sensors according to any one of items [1] to [6]), the element body may include an oxygen-ion-conductive solid electrolyte layer and has, inside, a measurement gas flow path configured to introduce and flow a measurement gas. The sensor element may further include a pump cell comprising an inner electrode disposed in an internal cavity of the measurement gas flow path and an outer electrode disposed on an outer surface of the element body. The control device may be configured to start pump control processing for controlling the pump cell to pump oxygen out from around the inner electrode to around the outer electrode, or to pump oxygen in from around the outer electrode to around the inner electrode, when the resistance-related value reaches a predetermined resistance-related value during execution of the heating control processing. The predetermined resistance-related value may be set to be smaller when the degree of degradation is equal to or greater than the predetermined degree than when the degree of degradation is less than the predetermined degree. Accordingly, when the degree of degradation is equal to or greater than the predetermined degree, the start timing of the pump control processing can be advanced.
[8] The control device according to the present invention is a control device for use in a gas sensor that comprises a sensor element having an element body and a resistive heating element provided inside the element body, and is configured to detect a concentration of a specific gas in a measurement gas,
wherein the control device is configured to perform heating control processing for controlling a voltage applied to the resistive heating element such that, when a degree of degradation of the resistive heating element is equal to or greater than a predetermined degree, a rate of change per unit time of a resistance-related value related to a resistance value of the resistive heating element is smaller than that when the degree of degradation is less than the predetermined degree, during heating of the element body.

The control device according to the present invention performs the heating control processing for controlling the voltage applied to the resistive heating element such that, when the degree of degradation of the resistive heating element is equal to or greater than the predetermined degree, the rate of change per unit time of the resistance-related value related to the resistance value of the resistive heating element is smaller than that when the degree of degradation is less than the predetermined degree, during heating of the element body. When the degree of degradation of the resistive heating element is equal to or greater than the predetermined degree, during heating of the element body by energizing the resistive heating element, the amount of heat generated at a deteriorated portion of the resistive heating element tends to locally increase, making a temperature gradient within the element body steeper than when the degree of degradation is less than the predetermined degree. In view of this tendency, by performing the heating control processing as described above, it is possible to suppress the temperature gradient within the element body from becoming steep during heating of the element body, thereby suppressing the occurrence of damage such as cracks in the element body.
[9] The control method according to the present invention is a control method for a gas sensor comprising a sensor element having an element body and a resistive heating element provided inside the element body, the gas sensor being configured to detect a concentration of a specific gas in a measurement gas,
the control method comprising performing heating control processing for controlling a voltage applied to the resistive heating element such that, when a degree of degradation of the resistive heating element is equal to or greater than a predetermined degree, a rate of change per unit time of a resistance-related value related to a resistance value of the resistive heating element is smaller than that when the degree of degradation is less than the predetermined degree, during heating of the element body.

The control method according to the present invention performs the heating control processing for controlling the voltage applied to the resistive heating element such that, when the degree of degradation of the resistive heating element is equal to or greater than the predetermined degree, the rate of change per unit time of the resistance-related value related to the resistance value of the resistive heating element is smaller than that when the degree of degradation is less than the predetermined degree, during heating of the element body. When the degree of degradation of the resistive heating element is equal to or greater than the predetermined degree, during heating of the element body by energizing the resistive heating element, the amount of heat generated at a deteriorated portion of the resistive heating element tends to locally increase, making a temperature gradient within the element body steeper than when the degree of degradation is less than the predetermined degree. In view of this tendency, by performing the heating control processing as described above, it is possible to suppress the temperature gradient within the element body from becoming steep during heating of the element body, thereby suppressing the occurrence of damage such as cracks in the element body.

### BRIEF DESCRIPTION OF THE DRAWINGS

FIG. 1 is an explanatory diagram schematically showing an example configuration of a gas sensor 100.

FIG. 2 is a schematic cross-sectional view schematically showing an example configuration of a sensor element 101.

FIG. 3 is a block diagram showing an electrical connection relationship between a control device 95 and each cell and other components.

FIG. 4 is a flowchart showing an example of a warm-up heater control processing routine.

FIG. 5 is an explanatory diagram showing an example of a reference-temperature resistance value estimation map.

FIG. 6 is an explanatory diagram showing an example of first and second heating curves Cht1 and Cht2.

FIG. 7 is a flowchart showing an example of a warm-up heater control processing routine according to a modified example.

FIG. 8 is a schematic cross-sectional view of a sensor element 201 according to a modified example.

### DETAILED DESCRIPTION OF THE INVENTION

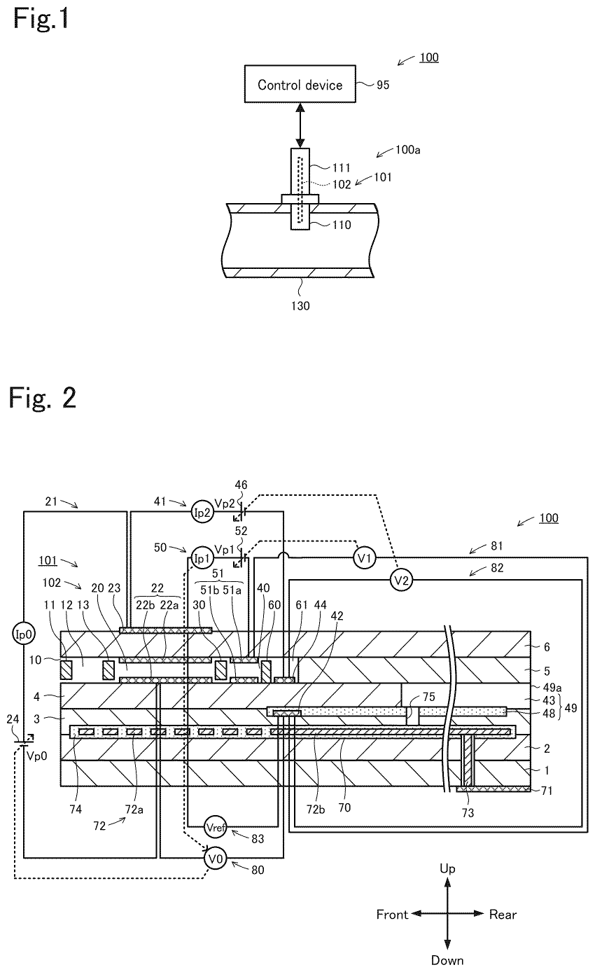

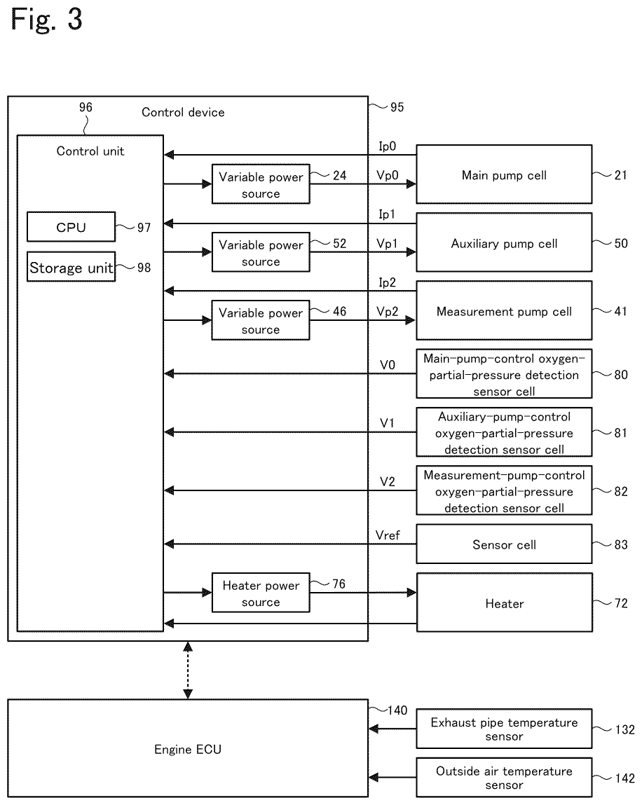

Next, an embodiment of the present invention will be described with reference to the drawings. FIG. 1 is an explanatory diagram schematically showing an example configuration of a gas sensor 100 according to an embodiment of the present invention. FIG. 2 is a schematic cross-sectional view schematically showing an example configuration of a sensor element 101 provided in the gas sensor 100. FIG. 3 is a block diagram showing an electrical connection relationship among a control device 95, each cell and a heater 72 of the sensor element 101.

As shown in FIG. 1, a gas sensor 100 includes a gas sensor main body 100a and a control device 95 that is electrically connected to the gas sensor main body 100a. The gas sensor main body 100a is mounted, for example, on an exhaust pipe 130 of an internal combustion engine of a vehicle. The gas sensor 100 is configured to detect a specific gas concentration, which is a concentration of a specific gas such as NOx or ammonia contained in the measurement gas, using exhaust gas within the exhaust pipe 130 as a measurement gas. In this embodiment, the gas sensor 100 is configured to detect an NOx concentration as the specific gas concentration.

The gas sensor main body 100a includes a sensor element 101 having an elongated rectangular parallelepiped element body 102, a protective cover 110 configured to protect a front-end portion of the element body 102, and a sensor assembly 111 configured to accommodate the element body 102. In this specification, a longitudinal direction (the left-right direction in FIG. 2) of the element body 102 is defined as a front-rear direction, a thickness direction (the up-down direction in FIG. 2) of the element body 102 is defined as an up-down direction, and a width direction (a direction perpendicular to both the front-rear direction and the up-down direction) is defined as a left-right direction. The protective cover 110 and the sensor assembly 111 seal a space around a front-end portion of the element body 102, which is exposed to the measurement gas (that is, a space inside the protective cover 110), from a space around a rear-end portion of the element body 102 in which a reference gas is enclosed.

addition to the element body 102, respective cells 21, 41, 50, and 80 to 83, and a heater section 70. The element body 102 is a laminated body in which six layers-a first substrate layer 1, a second substrate layer 2, a third substrate layer 3, a first solid electrolyte layer 4, a spacer layer 5, and a second solid electrolyte layer 6—each formed of an oxygen-ion-conductive solid electrolyte layer such as zirconia (ZrO₂), are laminated in this order from the lower side in plan view of the drawing. The solid electrolytes forming these six layers are dense and gastight. The element body 102 is manufactured, for example, by laminating ceramic green sheets corresponding to the respective layers after performing predetermined processing and printing of circuit patterns thereon, and then firing the layered body to be integrated.

At a front-end side (the left end side in FIG. 2) of the element body 102, between a lower surface of the second solid electrolyte layer 6 and an upper surface of the first solid electrolyte layer 4, a gas inlet 10, a first diffusion rate-limiting section 11, a buffer space 12, a second diffusion rate-limiting section 13, a first internal cavity (an oxygen concentration adjustment chamber) 20, a third diffusion rate-limiting section 30, a second internal cavity (an oxygen concentration adjustment chamber) 40, a fourth diffusion rate-limiting section 60, and a third internal cavity (a measurement chamber) 61 are formed so as to be adjacent to each other in this order while being in communication with one another.

The gas inlet 10, the buffer space 12, the first internal cavity 20, the second internal cavity 40, and the third internal cavity 61 are spaces inside the element body 102 provided by hollowing out the spacer layer 5, each space being defined at an upper side by the lower surface of the second solid electrolyte layer 6, at a lower side by the upper surface of the first solid electrolyte layer 4, and at side portions by side surfaces of the spacer layer 5.

The first diffusion rate-limiting section 11, the second diffusion rate-limiting section 13, and the third diffusion rate-limiting section 30 are each provided as two horizontally elongated slits (each having an opening whose longitudinal direction extends perpendicular to the plane of the drawing). The fourth diffusion rate-limiting section 60 is provided as a single horizontally elongated slit (having an opening whose longitudinal direction extends perpendicular to the plane of the drawing) formed as a gap with the lower surface of the second solid electrolyte layer 6. A portion extending from the gas inlet 10 to the third internal cavity 61 is also referred to as a measurement gas flow path.

The element body 102 includes a reference gas introduction portion 49 configured to flow a reference gas to a reference electrode 42 from outside the element body 102 when measuring an NOx concentration. The reference gas introduction portion 49 has a reference gas introduction space 43 and a reference gas introduction layer 48. The reference gas introduction space 43 is a space provided so as to extend from a rear-end surface of the element body 102 toward a front-end side. The reference gas introduction space 43 is provided between an upper surface of the third substrate layer 3 and a lower surface of the spacer layer 5, at a position where side portions thereof are defined by side surfaces of the first solid electrolyte layer 4. The reference gas introduction space 43 opens to the rear-end surface of the element body 102, and this opening functions as an inlet portion 49a of the reference gas introduction portion 49. The reference gas is introduced into the reference gas introduction space 43 through the inlet portion 49a. The reference gas introduction portion 49 introduces the reference gas introduced through the inlet portion 49a to the reference electrode 42 while imparting a predetermined diffusion resistance thereto. In this embodiment, air is used as the reference gas.

The reference gas introduction layer 48 is provided between the upper surface of the third substrate layer 3 and the lower surface of the first solid electrolyte layer 4. The reference gas introduction layer 48 is a porous body made of a ceramic such as alumina. A part of an upper surface of the reference gas introduction layer 48 is exposed to the reference gas introduction space 43. The reference gas introduction layer 48 is formed so as to cover the reference electrode 42. The reference gas introduction layer 48 allows the reference gas to flow from the reference gas introduction space 43 to the reference electrode 42.

The reference electrode 42 is an electrode formed in a state of being sandwiched between the upper surface of the third substrate layer 3 and the first solid electrolyte layer 4, and, as described above, the reference gas introduction layer 48 leading to the reference gas introduction space 43 is provided around the reference electrode 42. As will be described later, it is possible to measure oxygen concentration (oxygen partial pressure) in the first internal cavity 20, the second internal cavity 40, and the third internal cavity 61 by using the reference electrode 42. The reference electrode 42 is formed as a porous cermet electrode (for example, a cermet electrode of platinum (Pt) and zirconia (ZrO₂)).

In the measurement gas flow path, the gas inlet 10 is a portion opened to an external space, and a measurement gas is taken into the element body 102 from the external space through the gas inlet 10. The first diffusion rate-limiting section 11 is a portion that imparts a predetermined diffusion resistance to the measurement gas taken in through the gas inlet 10. The buffer space 12 is a space provided to guide the measurement gas introduced through the first diffusion rate-limiting section 11 to the second diffusion rate-limiting section 13. The second diffusion rate-limiting section 13 is a portion that imparts a predetermined diffusion resistance to the measurement gas introduced from the buffer space 12 into the first internal cavity 20. When the measurement gas is introduced from outside the element body 102 into the first internal cavity 20, the measurement gas rapidly taken into the element body 102 through the gas inlet 10 due to pressure fluctuation in the external space (when the measurement gas is exhaust gas from an internal combustion engine, pulsation of exhaust pressure) is not directly introduced into the first internal cavity 20, but after the pressure fluctuation of the measurement gas is canceled while passing through the first diffusion rate-limiting section 11, the buffer space 12, and the second diffusion rate-limiting section 13, the measurement gas is introduced into the first internal cavity 20. Accordingly, pressure fluctuation of the measurement gas introduced into the first internal cavity 20 becomes almost negligible. The first internal cavity 20 is provided as a space for adjusting an oxygen partial pressure of the measurement gas introduced through the second diffusion rate-limiting section 13. This oxygen partial pressure is adjusted by operation of a main pump cell 21.

The main pump cell 21 is an electrochemical pump cell constituted by: an inner pump electrode 22 having a ceiling electrode portion 22a provided on substantially the entire surface of the lower surface of the second solid electrolyte layer 6 facing the first internal cavity 20; an outer pump electrode 23 provided so as to be exposed to the outside of the element body 102 in a region corresponding to the ceiling electrode portion 22a on the upper surface of the second solid electrolyte layer 6; and the second solid electrolyte layer 6, the spacer layer 5, and the first solid electrolyte layer 4 which serve as a current path between these electrodes.

The inner pump electrode 22 is formed so as to extend over upper and lower solid electrolyte layers (the second solid electrolyte layer 6 and the first solid electrolyte layer 4) defining the first internal cavity 20 and over the spacer layer 5 providing side walls. Specifically, a ceiling electrode portion 22a is formed on the lower surface of the second solid electrolyte layer 6 defining a ceiling face of the first internal cavity 20, a bottom electrode portion 22b is formed on the upper surface of the first solid electrolyte layer 4 defining a bottom face of the first internal cavity 20, and a side electrode portion (not shown) connecting the ceiling electrode portion 22a and the bottom electrode portion 22b is formed on inner sidewall surfaces of the spacer layer 5 constituting both sidewall portions of the first internal cavity 20, the inner pump electrode 22 being arranged in a tunnel-type structure at the portions where the side electrode portion is provided.

The inner pump electrode 22 and the outer pump electrode 23 are formed as porous cermet electrodes (for example, a cermet electrode of platinum (Pt) containing 1% gold (Au) and zirconia (ZrO₂)). The inner pump electrode 22 that contacts the measurement gas is formed of a material whose reducing capability with respect to an NOx component in the measurement gas is suppressed.

In the main pump cell 21, by applying a desired voltage Vp0 between the inner pump electrode 22 and the outer pump electrode 23 and causing a pump current Ip0 to flow in a forward or reverse direction between the inner pump electrode 22 and the outer pump electrode 23, oxygen within the first internal cavity 20 can be pumped out to an external space, or oxygen in the external space can be pumped into the first internal cavity 20.

To detect oxygen concentration (oxygen partial pressure) in an atmosphere within the first internal cavity 20, a main-pump-control oxygen-partial-pressure detection sensor cell 80, which is an electrochemical sensor cell, is constituted by the inner pump electrode 22, the second solid electrolyte layer 6, the spacer layer 5, the first solid electrolyte layer 4, the third substrate layer 3, and the reference electrode 42.

By measuring an electromotive force (a voltage V0) of the main-pump-control oxygen-partial-pressure detection sensor cell 80, the oxygen concentration (oxygen partial pressure) within the first internal cavity 20 can be known. Further, by feedback-controlling the voltage Vp0 of a variable power source 24 such that the voltage V0 reaches a target value, the pump current Ip0 is controlled. Thus, the oxygen concentration within the first internal cavity 20 can be maintained at a predetermined constant value.

The third diffusion rate-limiting section 30 is a portion that imparts a predetermined diffusion resistance to the measurement gas whose oxygen concentration (oxygen partial pressure) has been controlled by operation of the main pump cell 21 in the first internal cavity 20, and that guides the measurement gas to the second internal cavity 40. The second internal cavity 40 is provided as a space for further adjusting oxygen partial pressure by an auxiliary pump cell 50 with respect to the measurement gas that has been introduced through the third diffusion rate-limiting section 30 after the oxygen concentration (oxygen partial pressure) has been adjusted in advance in the first internal cavity 20. Accordingly, since the oxygen concentration in the second internal cavity 40 can be kept constant with high accuracy, the gas sensor 100 can measure an NOx concentration with high accuracy.

The auxiliary pump cell 50 is an auxiliary electrochemical pump cell constituted by: an auxiliary pump electrode 51 having a ceiling electrode portion 51a provided on substantially the entire surface of the lower surface of the second solid electrolyte layer 6 facing the second internal cavity 40; the outer pump electrode 23 (not limited to the outer pump electrode 23, and any suitable electrode provided on an outer surface of the element body 102 may be used); and the second solid electrolyte layer 6, the spacer layer 5, and the first solid electrolyte layer 4.

The auxiliary pump electrode 51 is disposed within the second internal cavity 40 in a tunnel-type structure similar to the inner pump electrode 22 provided in the first internal cavity 20. That is, a ceiling electrode portion 51a is formed on the second solid electrolyte layer 6 giving a ceiling face of the second internal cavity 40, a bottom electrode portion 51b is formed on the first solid electrolyte layer 4 giving a bottom face of the second internal cavity 40, and a side electrode portion (not shown) connecting the ceiling electrode portion 51a and the bottom electrode portion 51b is formed on both wall surfaces of the spacer layer 5 giving side walls of the second internal cavity 40, thereby providing a tunnel-type structure. Like the inner pump electrode 22, the auxiliary pump electrode 51 is a porous cermet electrode formed of a material with suppressed reducing capability with respect to an NOx component in the measurement gas.

In the auxiliary pump cell 50, by applying a desired voltage Vp1 between the auxiliary pump electrode 51 and the outer pump electrode 23, oxygen in an atmosphere within the second internal cavity 40 can be pumped out to an external space, or oxygen can be pumped from the external space into the second internal cavity 40.

To control oxygen partial pressure in the atmosphere within the second internal cavity 40, an auxiliary-pump-control oxygen-partial-pressure detection sensor cell 81, which is an electrochemical sensor cell, is constituted by the auxiliary pump electrode 51, the reference electrode 42, the second solid electrolyte layer 6, the spacer layer 5, the first solid electrolyte layer 4, and the third substrate layer 3.

The auxiliary pump cell 50 performs pumping by a variable power source 52 whose voltage is controlled based on an electromotive force (a voltage V1) detected by the auxiliary-pump-control oxygen-partial-pressure detection sensor cell 81. As a result, the oxygen partial pressure in the atmosphere within the second internal cavity 40 is controlled to a low partial pressure that substantially does not affect the measurement of NOx.

In addition, the pump current Ip1 is also used for controlling the electromotive force of the main-pump-control oxygen-partial-pressure detection sensor cell 80. Specifically, the pump current Ip1 is input as a control signal to the main-pump-control oxygen-partial-pressure detection sensor cell 80, and by controlling the above-described target value of the voltage V0, the gradient of the oxygen partial pressure in the measurement gas introduced from the third diffusion rate-limiting section 30 into the second internal cavity 40 is controlled so as to remain constant. When the gas sensor 100 is used as an NOx sensor, the oxygen concentration in the second internal cavity 40 is maintained at a constant value of approximately 0.001 ppm by the operation of the main pump cell 21 and the auxiliary pump cell 50.

The fourth diffusion rate-limiting section 60 imparts a predetermined diffusion resistance to the measurement gas whose oxygen concentration (oxygen partial pressure) has been controlled by the operation of the auxiliary pump cell 50 in the second internal cavity 40, and guides the measurement gas to the third internal cavity 61. The fourth diffusion rate-limiting section 60 serves to limit the amount of NOx flowing into the third internal cavity 61.

The third internal cavity 61 is provided as a space for performing processing related to the measurement of the nitrogen oxide (NOx) concentration in the measurement gas, which has been introduced through the fourth diffusion rate-limiting section 60 after the oxygen concentration (oxygen partial pressure) has been adjusted in the second internal cavity 40. The measurement of the NOx concentration is mainly performed in the third internal cavity 61 by the operation of the measurement pump cell 41.

The measurement pump cell 41 measures the NOx concentration in the measurement gas within the third internal cavity 61. The measurement pump cell 41 is an electrochemical pump cell comprising a measurement electrode 44 provided on the upper surface of the first solid electrolyte layer 4 facing the third internal cavity 61, an outer pump electrode 23, the second solid electrolyte layer 6, the spacer layer 5, and the first solid electrolyte layer 4. The measurement electrode 44 is a porous cermet electrode formed using a material having a higher reduction capability for NOx components in the measurement gas than that of the inner pump electrode 22. The measurement electrode 44 also functions as an NOx reduction catalyst that reduces NOx present in the atmosphere within the third internal cavity 61.

In the measurement pump cell 41, oxygen generated by decomposition of nitrogen oxides in the atmosphere around the measurement electrode 44 is pumped out, and the amount of generated oxygen is detected as a pump current Ip2.

To detect the oxygen partial pressure around the measurement electrode 44, an electrochemical sensor cell-namely, a measurement-pump-control oxygen-partial-pressure detection sensor cell 82-is configured by the first solid electrolyte layer 4, the third substrate layer 3, the measurement electrode 44, and the reference electrode 42. Based on the electromotive force (voltage V2) detected by the measurement-pump-control oxygen-partial-pressure detection sensor cell 82, the variable power source 46 is controlled.

The measurement gas guided into the second internal cavity 40 reaches the measurement electrode 44 in the third internal cavity 61 through the fourth diffusion rate-limiting section 60 under a condition in which the oxygen partial pressure is controlled. The nitrogen oxides contained in the measurement gas around the measurement electrode 44 are reduced (2NO→N₂+O 2) to generate oxygen. The generated oxygen is pumped out by the measurement pump cell 41, and during this operation, the voltage Vp2 of the variable power source 46 is controlled such that the voltage V2 detected by the measurement-pump-control oxygen-partial-pressure detection sensor cell 82 remains constant (at a target value). Since the amount of oxygen generated around the measurement electrode 44 is proportional to the concentration of nitrogen oxides in the measurement gas, the concentration of nitrogen oxides in the measurement gas is calculated using the pump current Ip2 of the measurement pump cell 41.

Furthermore, by combining the measurement electrode 44, the first solid electrolyte layer 4, the third substrate layer 3, and the reference electrode 42 to configure an oxygen partial pressure detection means as an electrochemical sensor cell, an electromotive force corresponding to the difference between the amount of oxygen generated by the reduction of NOx components in the atmosphere around the measurement electrode 44 and the amount of oxygen contained in the reference atmosphere can be detected. Accordingly, the concentration of NOx components in the measurement gas can also be determined.

Further, an electrochemical sensor cell 83 is configured by the second solid electrolyte layer 6, the spacer layer 5, the first solid electrolyte layer 4, the third substrate layer 3, the outer pump electrode 23, and the reference electrode 42. Based on the electromotive force (reference voltage Vref) obtained from this sensor cell 83, the oxygen partial pressure of the measurement gas outside the element body 102 of the sensor element 101—specifically, around the outer pump electrode 23—can be detected.

In the gas sensor 100 having such a configuration, the measurement gas maintained at a constantly low oxygen partial pressure (a value substantially having no influence on the measurement of NOx) by operating the main pump cell 21 and the auxiliary pump cell 50 is supplied to the measurement pump cell 41. Accordingly, the concentration of NOx in the measurement gas can be determined based on the pump current Ip2 flowing as a result of oxygen generated by the reduction of NOx being pumped out from the measurement pump cell 41, which is approximately proportional to the NOx concentration in the measurement gas.

The heater section 70 serves to heat and maintain the temperature of the sensor element 101 in order to enhance the oxygen-ion conductivity of the solid electrolyte of the element body 102. The heater section 70 includes a heater connector electrode 71, a heater 72, a through-hole 73, a heater insulating layer 74, and a pressure relief hole 75. The heater section 70 further includes first, second, and third substrate layers 1, 2, and 3 made of ceramics. The heater section 70 is configured as a ceramic heater including the heater 72 and the second and third substrate layers 2 and 3 surrounding the heater 72.

The heater connector electrode 71 is an electrode formed so as to be in contact with the lower surface of the first substrate layer 1. By connecting the heater connector electrode 71 to a heater power source 76 (see FIG. 3), electric power can be supplied from the heater power source 76 to the heater section 70.

The heater 72 includes a heating portion 72a and a lead portion 72b. The heating portion 72a is a resistive heating element formed in a manner sandwiched vertically between the second substrate layer 2 and the third substrate layer 3. The heating portion 72a is embedded so as to extend over the entire region from the first internal cavity 20 to the third internal cavity 61. The heating portion 72a is in the form of a strip, and both ends thereof are connected to the lead portions 72b. The lead portions 72b, like the heating portion 72a, are formed so as to be sandwiched between the second and third substrate layers 2 and 3, and are connected to the heater connector electrode 71 via a through-hole 73.

In the present embodiment, the heating portion 72a and the lead portions 72b are integrally formed; however, they may alternatively be formed separately and then connected together. The heater 72 is formed of a cermet including a noble metal and a ceramic (for example, a cermet of platinum (Pt) and alumina (Al₂O₃)). The heater 72 is not limited to a cermet; it may be made of any conductive material containing a noble metal, for example, at least one metal selected from platinum, rhodium (Rh), gold (Au), and palladium (Pd), or an alloy thereof. When power is supplied from the heater power source 76 to the heater 72 through the heater connector electrode 71, the heating portion 72a generates heat to increase the temperature of the element body 102, specifically to activate the solid electrolyte of the element body 102 or to maintain its temperature.

The heater insulating layer 74 is an insulating layer formed of an insulator such as alumina on the upper and lower surfaces of the heater 72. The heater insulating layer 74 is formed to ensure electrical insulation between the second substrate layer 2 and the heater 72, and between the third substrate layer 3 and the heater 72.

The pressure relief hole 75 is a portion formed so as to penetrate through the third substrate layer 3 and the reference gas introduction layer 48 and communicate with the reference gas introduction space 43. The pressure relief hole 75 is provided for the purpose of alleviating an increase in internal pressure accompanying a temperature rise inside the heater insulating layer 74.

As shown in FIG. 3, the control device 95 includes the variable power sources 24, 46, and 52 described above, the heater power source 76 described above, and a control unit 96. The control unit 96 is a microprocessor including a CPU 97 and a storage unit 98. The storage unit 98 is a nonvolatile memory capable of rewriting information, and can store various programs and various data. The control unit 96 inputs as inputs a voltage V0 of the main-pump-control oxygen-partial-pressure detection sensor cell 80, a voltage V1 of the auxiliary-pump-control oxygen-partial-pressure detection sensor cell 81, a voltage V2 of the measurement-pump-control oxygen-partial-pressure detection sensor cell 82, a reference voltage Vref of the sensor cell 83, a pump current Ip0 flowing through the main pump cell 21, a pump current Ip1 flowing through the auxiliary pump cell 50, and a pump current Ip2 flowing through the measurement pump cell 41. The control unit 96 outputs control signals to the variable power sources 24, 46, and 52 to control voltages Vp0, Vp1, and Vp2 output from the respective variable power sources, thereby controlling the main pump cell 21, the measurement pump cell 41, and the auxiliary pump cell 50. The control unit 96 also outputs control signals to the heater power source 76 such that the heater power source 76 controls the supply voltage (supply power) to the heater 72. Target values such as V0*, V1*, and V2*, which will be described later, are stored in the storage unit 98. The CPU 97 of the control unit 96 refers to these target values V0*, V1*, and V2* to perform control processing for the respective pump cells 21, 41, and 50.

The control unit 96 performs auxiliary pump control processing to control the auxiliary pump cell 50 such that the oxygen concentration in the second internal cavity 40 becomes a target concentration. Specifically, the control unit 96 feedback-controls the voltage Vp1 of the variable power source 52 such that the voltage V1 becomes a constant value (referred to as a target value V1*), thereby controlling the auxiliary pump cell 50. The target value V1* is defined as a value such that the oxygen concentration in the second internal cavity 40 becomes a predetermined low concentration that does not substantially affect the measurement of NOx.

The control unit 96 performs main pump control processing to control the main pump cell 21 such that a pump current Ip1 flowing when the auxiliary pump cell 50 adjusts the oxygen concentration in the second internal cavity 40 through the auxiliary pump control processing becomes a target current (referred to as a target value Ip1*). Specifically, the control unit 96 sets (feedback-controls) a target value of the voltage V0 (referred to as a target value V0*) based on the pump current Ip1 such that the pump current Ip1 flowing according to the voltage Vp1 becomes the constant target value Ip1*. Then, the control unit 96 feedback-controls the voltage Vp0 of the variable power source 24 such that the voltage V0 becomes the target value V0* (that is, such that the oxygen concentration in the first internal cavity 20 becomes the target concentration). Through this main pump control processing, the gradient of the oxygen partial pressure in the measurement gas introduced from the third diffusion rate-limiting section 30 into the second internal cavity 40 is kept constant. The target value V0* is set to a value such that the oxygen concentration in the first internal cavity 20 becomes higher than 0% but remains at a low concentration. During this main pump control processing, the pump current Ip0 varies depending on the oxygen concentration of the measurement gas flowing into the measurement gas flow path from the gas inlet 10 (that is, the measurement gas surrounding the sensor element 101). Therefore, the control unit 96 can also detect the oxygen concentration in the measurement gas based on the pump current Ip0.

The main pump control processing and the auxiliary pump control processing described above are collectively referred to as adjustment pump control processing. The first internal cavity 20 and the second internal cavity 40 are collectively referred to as oxygen concentration adjustment chambers, and the main pump cell 21 and the auxiliary pump cell 50 are collectively referred to as adjustment pump cells. By performing the adjustment pump control processing, the control unit 96 controls the adjustment pump cells to adjust the oxygen concentration in the oxygen concentration adjustment chambers.

The control unit 96 performs measurement pump control processing to control the measurement pump cell 41 such that the voltage V2 becomes a constant value (referred to as a target value V2*), that is, such that the oxygen concentration in the third internal cavity 61 becomes a predetermined low concentration. Specifically, the control unit 96 feedback-controls the voltage Vp2 of the variable power source 46 such that the voltage V2 becomes the target value V2*, thereby controlling the measurement pump cell 41. Through this measurement pump control processing, oxygen is pumped out from the third internal cavity 61.

By performing the measurement pump control processing, oxygen generated in the third internal cavity 61 due to the reduction of NOx in the measurement gas becomes substantially zero, as the oxygen is pumped out from the third internal cavity 61. The control unit 96 obtains the pump current Ip2 as a detection value corresponding to oxygen generated in the third internal cavity 61 derived from the specific gas (NOx in the present embodiment), and calculates the concentration of the specific gas in the measurement gas based on the pump current Ip2.

In the storage unit 98, a relational expression (for example, a linear or quadratic function) or a map representing the correspondence between the pump current Ip2 and the concentration of NOx is stored. Such a relational expression or map can be obtained in advance through experimentation.

The control unit 96 performs heater control processing by outputting a control signal to the heater power source 76 such that the temperature of the heating portion 72a of the heater 72 reaches a target temperature Tht* (for example, approximately 700° C. to 900° C.). The inventors have confirmed through experiments and analysis that the relationship between the temperature of the heating portion 72a and the resistance ratio is determined by the material of the heating portion 72a and does not vary depending on the degree of degradation of the heating portion 72a. A similar finding is described in Literature A. The resistance ratio is a value obtained by dividing a resistance value of the heating portion 72a at its current temperature (current-temperature resistance value) by a resistance value of the heating portion 72a at a reference temperature Thtref (for example, approximately 20° C. to 30° C.). However, the resistance value of the heating portion 72a at the same temperature increases as the degree of degradation of the heating portion 72a increases. This is because, as the sensor element 101 is used over time, local degradation (wear) occurs in the heating portion 72a, causing an increase in the resistance value of the degraded portion, which in turn increases the overall resistance value of the heating portion 72a.
Non-Patent Literature A: Tadami Sakai, “Temperature Measurement (Measurement by Electrical Methods) (Part 1),” Journal of the Fuel Society, Vol. 53, No. 568, [online], [accessed Jan. 10, 2025], Internet <URL: https://www.jstage.jst.go.jp/article/jie1922/53/8/53_8_738/pdf/>

In the heater control processing, when operation of the gas sensor 100 is required, for example, at the start of operation of the internal combustion engine, the control unit 96 basically performs warm-up heater control processing followed by temperature-maintenance heater control processing.

In the warm-up heater control processing, the control unit 96 sequentially calculates a resistance ratio HR of the heating portion 72a as a value corresponding to the temperature of the heating portion 72a, and controls the voltage applied to the heating portion 72a such that the resistance ratio HR increases. Here, the control unit 96 calculates the resistance value Rht of the heating portion 72a by, for example, a three-terminal or four-terminal method, and calculates the resistance ratio HR by dividing the calculated resistance value Rht (current-temperature resistance value) by a reference-temperature resistance value Rht1. Alternatively, the control unit 96 may obtain the voltage of the heating portion 72a and the current flowing through the heating portion 72a, calculate the resistance value Rht based on the obtained voltage and current, and calculate the resistance ratio HR by dividing the calculated resistance value Rht (current-temperature resistance value) by the reference-temperature resistance value Rht1. Details of the warm-up heater control processing and the estimation method for the reference-temperature resistance value Rht1 will be described later. Through this warm-up heater control processing, the temperature of the heating portion 72a increases, and accordingly, the temperatures of the element body 102 and the electrodes 22, 23, 42, 44, and 51 also rise.

In the temperature-maintenance heater control processing, the control unit 96 sequentially calculates the resistance ratio HR of the heating portion 72a and controls the voltage applied to the heating portion 72a such that the resistance ratio HR is maintained around a temperature-maintenance target resistance ratio HRk*. Specifically, the control unit 96 feedback-controls the heater power source 76 such that the difference between the resistance ratio HR and the temperature-maintenance target resistance ratio HRk* is cancelled, thereby controlling the voltage applied to the heating portion 72a. The temperature-maintenance target resistance ratio HRk* corresponds to the target temperature Tht* and is defined within a temperature range in which the solid electrolyte of the element body 102 becomes active.

Through this temperature-maintenance heater control processing, the temperature of the heating portion 72a is maintained around the target temperature Tht*. When supplying power to the heating portion 72a, the heater power source 76 adjusts the voltage (supply power) applied to the heating portion 72a based on control signals from the control unit 96.

It should be noted that, including the variable power sources 24, 46, and 52 and the heater power source 76 shown in FIG. 3, the control device 95 is connected to the sensor element 101. Specifically, the control device 95 is connected to each of the electrodes 22, 23, 42, 44, and 51 via lead wires and connector electrodes (not shown), and is also connected to the heater 72 via the through-hole 73 and the heater connector electrode 71.

The control device 95 communicates with an electronic control unit for an internal combustion engine (hereinafter referred to as the “engine ECU”) 140. The engine ECU 140 inputs signals from various sensors of the internal combustion engine other than the gas sensor 100 and performs operational control of the engine. Examples of such sensors include an exhaust pipe temperature sensor 132 attached to the exhaust pipe 130 and an outside air temperature sensor 142 installed on a vehicle equipped with the internal combustion engine.

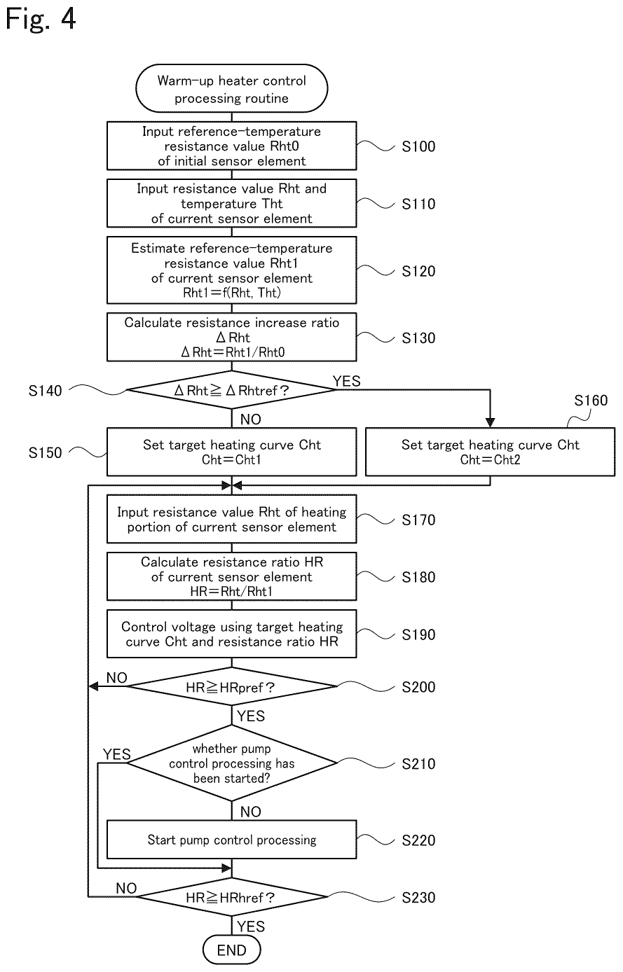

Next, warm-up heater control processing will be described. FIG. 4 is a flowchart showing an example of a warm-up heater control processing routine performed by the CPU 97 of the control unit 96. This routine is stored in the storage unit 98 of the control unit 96 and is performed by the CPU 97 when activation of the gas sensor 100 is required.

In the routine of FIG. 4, the CPU 97 first inputs a reference-temperature resistance value Rht0 of the heating portion 72a of the heater 72 of an initial sensor element 101 (for example, a new sensor element 101) (step S100). Here, the reference-temperature resistance value Rht0 may be a predetermined value (specification value) based on the specifications of the initial sensor element, or a value obtained in advance through experiments or other like prior to shipment of the current sensor element 101 (that is, the sensor element 101 attached to the exhaust pipe 130).

Then, the CPU 97 inputs a resistance value Rht and a temperature Tht of the heating portion 72a of the current sensor element (step S110). Here, the resistance value Rht of the heating portion 72a is the value calculated by the method described above. The temperature Tht of the heating portion 72a is obtained using the exhaust pipe temperature Tex detected by the exhaust pipe temperature sensor 132 and the outside air temperature Tout detected by the outside air temperature sensor 142, which are transmitted to the control device 95 via the engine ECU 140. Alternatively, the exhaust pipe temperature Tex and the outside air temperature Tout may be directly input to the control device 95 without passing through the engine ECU 140. In the present embodiment, when activation of the gas sensor 100 is required, it is assumed that the temperature Tht of the heating portion 72a is approximately equal to the exhaust pipe temperature Tex or the outside air temperature Tout.

After step S110, the CPU 97 estimates a reference-temperature resistance value Rht1 of the heating portion 72a of the current sensor element based on the resistance value Rht and the temperature Tht (step S120). Here, in the present embodiment, the reference-temperature resistance value Rht1 of the current sensor element is estimated by applying the resistance value Rht and the temperature Tht to a reference-temperature resistance estimation map that defines the relationship among the resistance value Rht, the temperature Tht, and the reference-temperature resistance value Rht1, which has been determined in advance through experiments or analysis. The corresponding reference-temperature resistance value Rht1 is derived from this map. FIG. 5 is an explanatory diagram showing an example of the reference-temperature resistance estimation map. As described above, the relationship between the temperature of the heating portion 72a and the resistance ratio does not change depending on the degree of degradation of the heating portion 72a. In addition, the resistance value of the heating portion 72a at the same temperature increases as the degree of degradation of the heating portion 72a increases.

After step S120, the CPU 97 calculates a resistance increase ratio ΔRht by dividing the reference-temperature resistance value Rht1 of the heating portion 72a of the current sensor element by the reference-temperature resistance value Rht of the heating portion 72a of the initial sensor element (step S130), and compares the calculated resistance increase ratio ΔRht with a threshold ΔRhtref (step S140). Since the resistance value Rht (specifically, the reference-temperature resistance value Rht1) of the heating portion 72a at the same temperature increases as the degree of degradation of the heating portion 72a increases, the resistance increase ratio ΔRht corresponds to the degree of degradation of the heating portion 72a. The threshold ΔRhtref is a threshold used to determine whether the degree of degradation of the heating portion 72a is equal to or greater than a predetermined degree (relatively large), and, for example, a value of about 0.55% to 0.65% is used.

When the CPU 97 determines in step S140 that the resistance increase ratio ΔRht is less than the threshold ΔRhtref, it determines that the degree of degradation of the heating portion 72a is less than the predetermined degree, and sets a first heating curve Cht1 as a target heating curve Cht (step S150). On the other hand, when the CPU 97 determines in step S140 that the resistance increase ratio ΔRht is equal to or greater than the threshold ΔRhtref, it determines that the degree of degradation of the heating portion 72a is equal to or greater than the predetermined degree, and sets a second heating curve Cht2 as the target heating curve Cht (step S160).

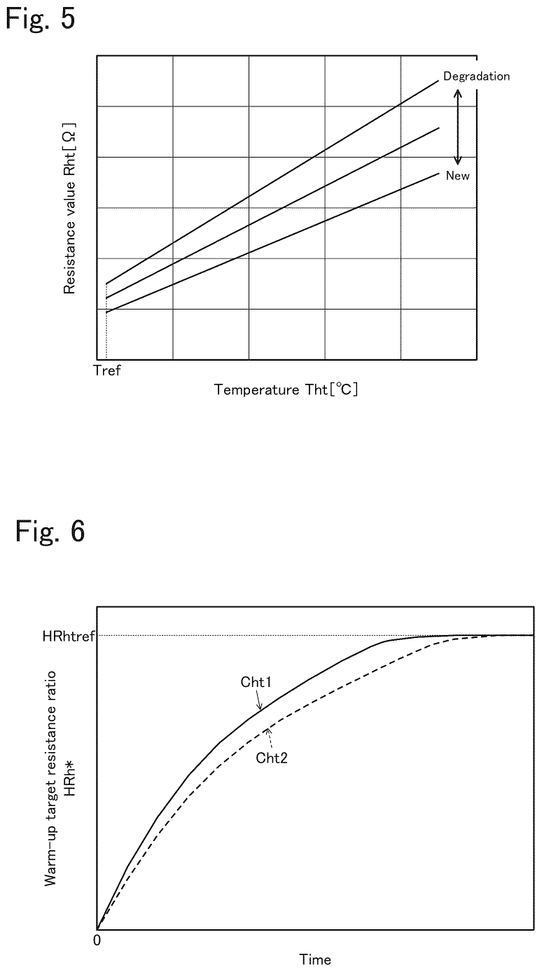

FIG. 6 is an explanatory diagram showing an example of the first and second heating curves Cht1 and Cht2. The first and second heating curves Cht1 and Cht2 are curves that define how a warm-up target resistance ratio HRh* changes over time. For example, in the first and second heating curves Cht1 and Cht2, a resistance ratio HR obtained by dividing the resistance value Rht input in step S110 by the reference-temperature resistance value Rht1 calculated in step S120, that is, the resistance ratio HR immediately before the start of the warm-up heater control processing (steps S170 to S190 described below), is used as an initial value (at time zero) of the warm-up target resistance ratio HRh*. The second heating curve Cht2 is defined such that the rate of increase (change amount) per unit time of the warm-up target resistance ratio HRh*, in particular, the maximum rate of increase per unit time of the warm-up target resistance ratio HRh*, is smaller than that of the first heating curve Cht1. Specifically, the first heating curve Cht1 is determined in advance through experiments or analysis such that, when the resistance increase ratio ΔRht is less than the threshold ΔRhtref, the rate of increase per unit time of the warm-up target resistance ratio HRh* in each region (temperature region of the heating portion 72a) remains within a range that does not cause damage such as cracking to the element body 102. The second heating curve Cht2 is also determined in advance through experiments or analysis such that, when the resistance increase ratio ΔRht is equal to or greater than the threshold ΔRhtref, the rate of increase per unit time of the warm-up target resistance ratio HRh* in each region remains within a range that does not cause damage to the element body 102.

After step S150 or step S160, the CPU 97 performs the warm-up heater control processing (steps S170 to S190). In the warm-up heater control processing, the CPU 97 first inputs a resistance value Rht of the heating portion 72a of the current sensor element (step S170). Then, the CPU 97 calculates a resistance ratio HR by dividing the input resistance value Rht by the reference-temperature resistance value Rht1 (step S180). The CPU 97 feedback-controls the heater power source 76 such that the difference between the resistance ratio HR and the warm-up target resistance ratio HRh* at the current time on the target heating curve Cht is cancelled, thereby controlling the voltage applied to the heating portion 72a (step S190). Through this warm-up heater control processing, the resistance ratio HR increases along the target heating curve Cht.

When the sensor element 101 is used over time, local degradation (wear) may occur in the heating portion 72a, and the resistance value in such degraded portions increases. During heating of the element body 102 by energizing the heating portion 72a, the amount of heat generated at the degraded portion (worn portion) of the heating portion 72a tends to locally increase, making the temperature gradient between the degraded portion and the surrounding portion of the heating portion 72a—and hence the temperature gradient within the element body 102—steeper. When the temperature gradient within the element body 102 becomes large, cracks or other damage may occur in the element body 102. In view of this, in the present embodiment, when the resistance increase ratio ΔRht is equal to or greater than the threshold ΔRhtref, the CPU 97 sets the target heating curve Cht such that the rate of increase per unit time (in particular, the maximum rate of increase per unit time) of the warm-up target resistance ratio HRh* is smaller than that when the resistance increase ratio ΔRht is less than the threshold A Rhtref, and controls the voltage applied to the heating portion 72a such that the resistance ratio HR increases along the target heating curve Cht. As a result, even when the resistance increase ratio ΔRht is equal to or greater than the threshold ΔRhtref, it is possible to suppress an excessive increase in the rate of change per unit time (particularly, the maximum rate) of the resistance ratio HR compared to when ΔRht is less than the threshold ΔRhtref. Therefore, even when the resistance increase ratio ΔRht is equal to or greater than the threshold ΔRhtref, the heating control suppresses the temperature gradient between the degraded portion of the heating portion 72a and its surrounding portion, and thus suppresses a steep temperature gradient within the element body 102, preventing damage such as cracks in the element body 102.

After step S190, the CPU 97 compares the resistance ratio HR with a threshold HRpref (step S200). Here, the threshold HRpref is a threshold used to determine whether to start pump control processing (that is, adjustment pump control processing and measurement pump control processing), and a value slightly lower than a threshold HRhref is used. The threshold HRhref is a threshold used to determine whether to terminate the warm-up heater control processing, and a value equal to or slightly lower than the above-described temperature-maintenance target resistance ratio HRk* is used. When the CPU 97 determines in step S200 that the resistance ratio HR is less than the threshold HRpref, the process returns to step S170.

When the CPU 97 determines in step S200 that the resistance ratio HR is equal to or greater than the threshold HRpref, it determines whether the pump control processing has already been started (step S210). When the CPU 97 determines that the pump control processing has not yet been started, it starts the pump control processing (step S220). On the other hand, when the CPU 97 determines that the pump control processing has already been started, step S220 is skipped. When the pump control processing is started, the oxygen concentration in the oxygen concentration adjustment chambers is adjusted by the adjustment pump control processing, and the concentration of a specific gas in the measurement gas is detected by the measurement pump control processing.

The CPU 97 then compares the resistance ratio HR with the threshold HRhref (step S230). When the CPU 97 determines that the resistance ratio HR is less than the threshold HRhref, the process returns to step S170. When the CPU 97 determines in step S230 that the resistance ratio HR is equal to or greater than the threshold HRhref, this routine is terminated. When the CPU 97 terminates this routine, it switches from the warm-up heater control processing to the temperature-maintenance heater control processing.

Here, the correspondence between the components of this embodiment and those of the present invention will be clarified. The element body 102 of this embodiment corresponds to the element body; the heating portion 72a of the heater 72 corresponds to the resistive heating element; the sensor element 101 corresponds to the sensor element; and the control device 95 corresponds to the control device. The main pump cell 21, the auxiliary pump cell 50, and the measurement pump cell 41 correspond to the pump cells.

In the gas sensor 100 of this embodiment described in detail above, the CPU 97 controls the voltage applied to the heating portion 72a of the heater 72 such that the resistance ratio HR increases along the target heating curve Cht when the element body 102 is heated. In this case, when the resistance increase ratio ΔRht is equal to or greater than the threshold ΔRhtref, the CPU 97 sets the target heating curve Cht such that the rate of increase per unit time (particularly, the maximum rate of increase per unit time) of the warm-up target resistance ratio HRh* is smaller than that when the resistance increase ratio ΔRht is less than the threshold ΔRhtref. Accordingly, when the resistance increase ratio ΔRht is equal to or greater than the threshold ΔRhtref, an excessive increase in the rate of change per unit time (particularly, the maximum rate) of the resistance ratio HR compared to when ΔRht is less than the threshold ΔRhtref can be suppressed. Therefore, even when the resistance increase ratio ΔRht is equal to or greater than the threshold ΔRhtref, the heating control can suppress steep temperature gradients between the degraded portion of the heating portion 72a and its surrounding portion, as well as within the element body 102, thereby preventing damage such as cracks in the element body 102.

It should be understood that the present invention is not limited to the embodiment described above and may be implemented in various forms without departing from the technical scope of the present invention.

In the above-described embodiment, the CPU 97 sets the target heating curve Cht based on whether the resistance increase ratio ΔRht is equal to or greater than the threshold ΔRhtref when heating the element body 102, and controls the voltage applied to the heating portion 72a of the heater 72 such that the resistance ratio HR increases along the target heating curve Cht; however, the present invention is not limited thereto. It is sufficient that, when the CPU 97 heats the element body 102, it controls the voltage applied to the heating portion 72a such that, when the resistance increase ratio ΔRht is equal to or greater than the threshold ΔRhtref, a rate of increase per unit time of the resistance ratio HR becomes smaller than when the resistance increase ratio ΔRht is less than the threshold ΔRhtref.

For example, when heating the element body 102, the CPU 97 may sequentially calculate a warm-up target resistance ratio HRh* based on whether the resistance increase ratio ΔRht is equal to or greater than the threshold ΔRhtref, and may control the voltage applied to the heating portion 72a of the heater 72 so as to cancel a difference between the resistance ratio HR and the warm-up target resistance ratio HRh*. In this case, when the resistance increase ratio ΔRht is equal to or greater than the threshold ΔRhtref, the CPU 97 may sequentially calculate the warm-up target resistance ratio HRh* by a rate processing using a smaller rate value than when the resistance increase ratio ΔRht is less than the threshold ΔRhtref. Further, when the resistance increase ratio ΔRht is equal to or greater than the threshold ΔRhtref, the CPU 97 may sequentially calculate the warm-up target resistance ratio HRh* by an annealing processing using a larger time constant than when the resistance increase ratio ΔRht is less than the threshold 4 Rhtref.

For example, when heating the element body 102, the CPU 97 may apply a first voltage Vht1 to the heating portion 72a when the resistance increase ratio ΔRht is less than the threshold ΔRhtref, and may apply a second voltage Vht2, which is lower than the first voltage Vht1, to the heating portion 72a when the resistance increase ratio ΔRht is equal to or greater than the threshold ΔRhtref.

In the above-described embodiment, when heating the element body 102, the CPU 97 controls the voltage applied to the heating portion 72a of the heater 72 based on the resistance ratio HR; however, the present invention is not limited thereto. For example, a temperature of any one of the element body 102 and the electrodes 22, 23, 42, 44, and 51 may be detected or estimated as a target temperature, and the voltage applied to the heating portion 72a may be controlled based on the target temperature. For example, when the temperature of the measurement electrode 44 is used as the target temperature, the target temperature may be detected by a temperature sensor or may be estimated based on an impedance between the measurement electrode 44 and the auxiliary pump electrode 51. In this case, when the resistance increase ratio ΔRht is equal to or greater than the threshold ΔRhtref, the CPU 97 only needs to control the voltage applied to the heating portion 72a such that a rate of increase per unit time (amount of change) of the target temperature becomes smaller than when the resistance increase ratio ΔRht is less than the threshold ΔRhtref. In addition, an impedance between any two electrodes among the electrodes 22, 23, 42, 44, and 51 may be detected as a target impedance, and the voltage applied to the heating portion 72a may be controlled based on the target impedance. In this case, when the resistance increase ratio ΔRht is equal to or greater than the threshold ΔRhtref, the CPU 97 only needs to control the voltage applied to the heating portion 72a such that a rate of decrease per unit time (amount of change) of the target impedance becomes smaller than when the resistance increase ratio ΔRht is less than the threshold ΔRhtref.

In the above-described embodiment, when the resistance increase ratio ΔRht obtained by dividing the reference-temperature resistance value Rht1 of the heating portion 72a of the current sensor element by the reference-temperature resistance value Rht0 of the heating portion 72a of the initial sensor element is equal to or greater than the threshold ΔRhtref, the CPU 97 determines that the degree of degradation of the heating portion 72a is equal to or greater than a predetermined degree (relatively large); however, the present invention is not limited thereto. For example, when a resistance increase amount ΔRht2 obtained by subtracting the reference-temperature resistance value Rht0 from the reference-temperature resistance value Rht1 is equal to or greater than a threshold ΔRhtref2, it may be determined that the degree of degradation of the heating portion 72a is equal to or greater than a predetermined degree.

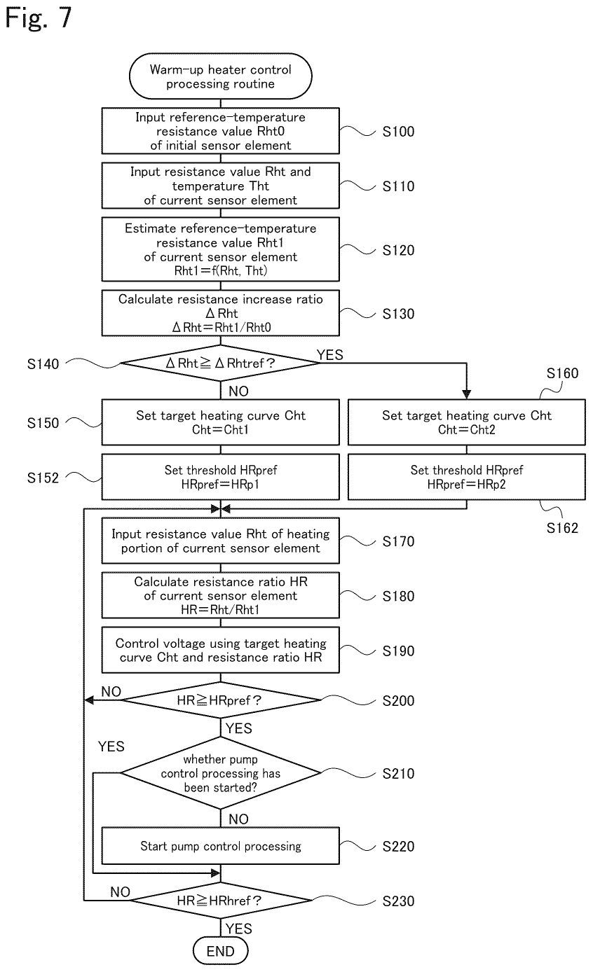

In the above-described embodiment, the threshold HRpref used to determine whether to start the pump control processing (that is, the adjustment pump control processing and the measurement pump control processing) is assumed to be a fixed value; however, the present invention is not limited thereto. For example, instead of executing the warm-up heater control processing routine of FIG. 4, the CPU 97 may execute the warm-up heater control processing routine of FIG. 7. The routine of FIG. 7 differs from the routine of FIG. 4 in that steps S152 and S162 are added.

In the routine of FIG. 7, when the CPU 97 determines in step S140 that the resistance increase ratio ΔRht is less than the threshold ΔRhtref, it determines that the degree of degradation of the heating portion 72a is less than a predetermined degree, sets the first heating curve Cht1 as the target heating curve Cht (step S150), sets a first value HRp1 as the threshold HRpref (step S152), and then proceeds to step S170. On the other hand, when the CPU 97 determines in step S140 that the resistance increase ratio ΔRht is equal to or greater than the threshold A Rhtref, it determines that the degree of degradation of the heating portion 72a is equal to or greater than a predetermined degree, sets the second heating curve Cht2 as the target heating curve Cht (step S160), sets a second value HRp2 as the threshold HRpref (step S162), and then proceeds to step S170. Here, as the first value HRp1, for example, the same value as the threshold HRpref used in the routine of FIG. 4 is used. As the second value HRp2, a value lower than the first value HRp1 is used. The CPU 97 increases the resistance ratio HR along the first heating curve Cht1 when the resistance increase ratio ΔRht is less than the threshold ΔRhtref, and increases the resistance ratio HR along the second heating curve Cht2 when the resistance increase ratio ΔRht is equal to or greater than the threshold ΔRhtref. Therefore, when the resistance increase ratio ΔRht is equal to or greater than the threshold ΔRhtref, the resistance ratio HR (temperature of the heating portion 72a) increases more gradually than when the resistance increase ratio ΔRht is less than the threshold ΔRhtref, that is, a longer time is required to reach the same resistance ratio. Accordingly, when the resistance ratio HR is the same in the case where the resistance increase ratio ΔRht is equal to or greater than the threshold ΔRhtref and in the case where the resistance increase ratio ΔRht is less than the threshold ΔRhtref, it is assumed that the temperatures of the element body 102 and the electrodes 22, 23, 42, 44, and 51, etc., are higher when the resistance increase ratio ΔRht is equal to or greater than the threshold ΔRhtref than when the resistance increase ratio ΔRht is less than the threshold A Rhtref. In view of this, in the modified example, when the resistance increase ratio ΔRht is equal to or greater than the threshold ΔRhtref, the threshold HRpref is set lower than when the resistance increase ratio ΔRht is less than the threshold ΔRhtref. By such processing, when the resistance increase ratio ΔRht is equal to or greater than the threshold ΔRhtref, the start timing of the pump control processing can be advanced. As a result, the start timing of detection of the concentration of the specific gas in the measurement gas can be advanced.

In the above-described embodiment, as the main pump control processing, the CPU 97 sets (by feedback control) a target value V0* of the voltage V0 based on the pump current Ip1 such that the pump current Ip1 becomes a target value Ip1*, and feedback-controls a pump voltage Vp0 such that the voltage V0 becomes the target value V0*; however, the present invention is not limited thereto. For example, as the main pump control processing, the CPU 97 may feedback-control the pump voltage Vp0 based on the pump current Ip1 such that the pump current Ip1 becomes the target value Ip1*. That is, the control unit 96 may omit acquisition of the voltage V0 from the main-pump-control oxygen-partial-pressure detection sensor cell 80 and setting of the target value V0*, and may directly control the pump voltage Vp0 (and hence control the pump current Ip0) based on the pump current Ip1.

In the above-described embodiment, the outer pump electrode 23 plays a role as an electrode paired with the inner pump electrode 22 in the main pump cell 21 (also referred to as the outer main pump electrode), a role as an electrode paired with the auxiliary pump electrode 51 in the auxiliary pump cell 50 (also referred to as the outer auxiliary pump electrode), and a role as an electrode paired with the measurement electrode 44 in the measurement pump cell 41 (also referred to as the outer measurement electrode); however, the present invention is not limited thereto. One or more of the outer main pump electrode, the outer auxiliary pump electrode, and the outer measurement electrode may be disposed, separately from the outer pump electrode 23, on the outer surface of the element body 102 so as to be in contact with the measurement gas.

In the above-described embodiment, the oxygen concentration adjustment chambers are assumed to include the first internal cavity 20 and the second internal cavity 40; however, the present invention is not limited thereto. For example, the oxygen concentration adjustment chambers may further include another internal cavity, or one of the first internal cavity 20 and the second internal cavity 40 may be omitted. Similarly, in the above-described embodiment, the adjustment pump cells are assumed to include the main pump cell 21 and the auxiliary pump cell 50; however, the present invention is not limited thereto. For example, the adjustment pump cells may further include another pump cell, or one of the main pump cell 21 and the auxiliary pump cell 50 may be omitted. For example, when the oxygen concentration of the measurement gas can be sufficiently lowered by the main pump cell 21 alone, the auxiliary pump cell 50 may be omitted. When the auxiliary pump cell 50 is omitted, the control unit 96 only needs to perform the main pump control processing as the adjustment pump control processing. In this case, in the main pump control processing, the above-described setting of the target value V0* based on the pump current Ip1 may be omitted. Specifically, a predetermined target value V0* may be stored in advance in the storage unit 98, and the control unit 96 may control the main pump cell 21 by feedback-controlling the voltage Vp0 of the variable power source 24 such that the voltage V0 becomes the target value V0*.

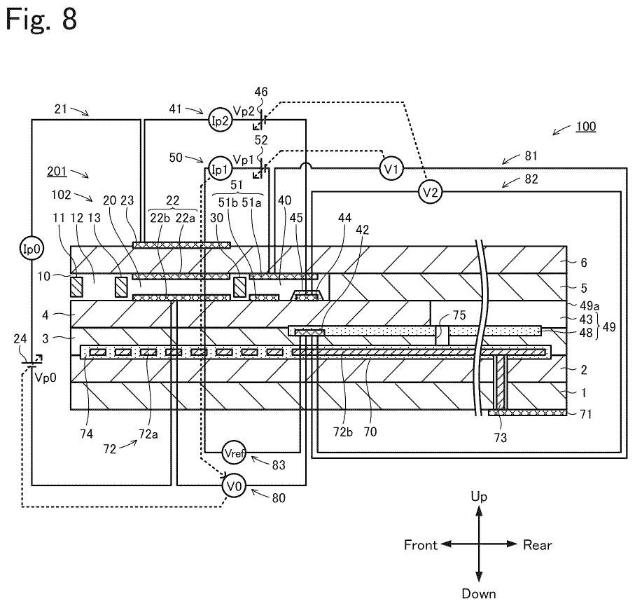

In the above-described embodiment, the sensor element 101 of the gas sensor 100 includes the first internal cavity 20, the second internal cavity 40, and the third internal cavity 61; however, the present invention is not limited thereto. For example, as shown in a modified example of the sensor element 201 in FIG. 8, the third internal cavity 61 may be omitted. In the sensor element 201 of the modified example in FIG. 8, between the lower surface of the second solid electrolyte layer 6 and the upper surface of the first solid electrolyte layer 4, a gas inlet 10, a first diffusion rate-limiting section 11, a buffer space 12, a second diffusion rate-limiting section 13, a first internal cavity 20, a third diffusion rate-limiting section 30, and a second internal cavity 40 are adjacently formed in such a manner that they communicate with each other in this order. A measurement electrode 44 is disposed on the upper surface of the first solid electrolyte layer 4 within the second internal cavity 40. The measurement electrode 44 is covered by a fourth diffusion rate-limiting section 45. The fourth diffusion rate-limiting section 45 is a membrane formed of a ceramic porous body such as alumina (Al₂O₃). The fourth diffusion rate-limiting section 45 serves to limit the amount of NOx flowing into the measurement electrode 44, similarly to the fourth diffusion rate-limiting section 60 in the above-described embodiment. The fourth diffusion rate-limiting section 45 also functions as a protective film for the measurement electrode 44. A ceiling electrode portion 51a of the auxiliary pump electrode 51 is formed up to a position directly above the measurement electrode 44. Even with such a configuration of the sensor element 201, the NOx concentration can be detected by the measurement pump cell 41 in the same manner as in the above-described embodiment. In the sensor element 201 of FIG. 8, a region surrounding the measurement electrode 44 functions as the measurement chamber; that is, the region surrounding the measurement electrode 44 plays the same role as the third internal cavity 61.

In the above-described embodiment, the sensor element 101 detects the NOx concentration in the measurement gas; however, the present invention is not limited thereto as long as the sensor element detects the concentration of a specific gas in the measurement gas. For example, the specific gas may be an oxide other than NOx. When the specific gas is an oxide, oxygen is generated when the specific gas itself is reduced in the third internal cavity 61, as in the above-described embodiment. Therefore, the measurement pump cell 41 can obtain a detection value (for example, a pump current Ip2) corresponding to the generated oxygen and detect the concentration of the specific gas. The specific gas may also be a non-oxide such as ammonia. When the specific gas is a non-oxide, oxygen is generated when the converted gas (for example, NO in the case of ammonia) is reduced in the third internal cavity 61 after converting the specific gas into an oxide (for example, converting ammonia into NO). Therefore, the measurement pump cell 41 can obtain a detection value (for example, a pump current Ip2) corresponding to the generated oxygen and detect the concentration of the specific gas. For example, the inner pump electrode 22 in the first internal cavity 20 can function as a catalyst to convert ammonia into NO within the first internal cavity 20.

In the above-described embodiment, the element body 102 of the sensor element 101 is configured as a laminated body having a plurality of solid electrolyte layers (layers 1 to 6); however, the present invention is not limited thereto. The element body 102 only needs to include at least one oxygen-ion-conductive solid electrolyte layer. For example, in FIG. 2, the layers 1 to 5 other than the second solid electrolyte layer 6 may be layers made of materials other than solid electrolytes (for example, layers made of alumina). In this case, each electrode included in the sensor element 101 may be disposed on the second solid electrolyte layer 6. For example, the measurement electrode 44 in FIG. 2 may be disposed on the lower surface of the second solid electrolyte layer 6. Furthermore, instead of providing the reference gas introduction space 43 in the first solid electrolyte layer 4, it may be provided in the spacer layer 5; and instead of providing the reference gas introduction layer 48 between the first solid electrolyte layer 4 and the third substrate layer 3, it may be provided between the second solid electrolyte layer 6 and the spacer layer 5. In addition, the reference electrode 42 may be provided at a position behind the third internal cavity 61 and on the lower surface of the second solid electrolyte layer 6.

In the above-described embodiment, the gas sensor 100 includes the sensor elements 101, 201 and the control device 95; however, the present invention is not limited thereto. The invention may also be embodied as the control device 95 used in the gas sensor 100, or as a control method for the gas sensor 100.

### Examples

Hereinafter, an example in which a sensor element is specifically fabricated will be described as an embodiment. It should be noted that the present invention is not limited to the following embodiment.

### Experimental Examples 1 to 4

As shown in Table 1, six sensor elements 101 having a resistance increase ratio ΔRht of 0% were prepared as Experimental Example 1. As Experimental Example 2, six sensor elements 101 having a resistance increase ratio ΔRht greater than 0% and not greater than 0.60% were prepared. As Experimental Example 3, six sensor elements 101 having a resistance increase ratio ΔRht greater than 0.60% and not greater than 1.10% were prepared. As Experimental Example 4, six sensor elements 101 having a resistance increase ratio ΔRht greater than 1.10% and not greater than 2.10% were prepared. In all 24 sensor elements 101 of Experimental Examples 1 to 4, the heater 72 (heating portion 72a) was a cermet of platinum and alumina. In all 24 sensor elements 101, the resistance increase ratio ΔRht was calculated by setting the reference temperature Thtref to 25° C.

TABLE 1

| | Number | | Number of failures/ | |
|---|---|---|---|---|
| | of | Resistance increase | Number of tests | |
| Sample | specimens | ratio Δ Rh[%] | 8[V] | 9[V] |
| Experimental | 6 | 0 | 0/3 | 0/3 |
| Example 1 | | | | |
| Experimental | 6 | More than 0 to 0.60 | 0/3 | 0/3 |
| Example 2 | | or less | | |
| Experimental | 6 | More than 0.60 to 1.10 | 0/3 | 2/3 |
| Example 3 | | or less | | |
| Experimental | 6 | More than 1.10 to 2.10 | 0/3 | 3/3 |
| Example 4 | | or less | | |

### [Evaluation Test]

For each of three sensor elements 101 of Experimental Example 1, a DC power supply was connected to apply a voltage of 8 V to the heating portion 72a of the sensor element 101, the resistance ratio HR was increased up to the threshold HRhref, and it was visually checked whether or not cracks or other damages occurred in the element body 102 of the sensor element 101. The threshold HRhref was set to a resistance ratio corresponding to 800° C. Further, for the other three sensor elements 101 of Experimental Example 1, a voltage of 9 V was applied to the heating portion 72a of each sensor element 101 through a DC power supply, the resistance ratio HR was increased up to the threshold HRhref, and it was visually checked whether or not damage occurred in the element body 102. The same evaluation tests were performed on each of the six sensor elements of Experimental Examples 2 to 4.

### [Results]

As shown in Table 1, in the evaluation test, when 8 V was applied to the heating portion 72a of the sensor element 101, the number of sensor elements 101 in which the element body 102 was damaged was zero in all of Experimental Examples 1 to 4. However, when 9 V was applied to the heating portion 72a of the sensor element 101, the number of sensor elements 101 in which the element body 102 was damaged was zero in Experimental Examples 1 and 2, whereas it was two in Experimental Example 3 and three in Experimental Example 4. Accordingly, when a relatively high voltage is applied to the heating portion 72a to increase the resistance ratio HR, it can be said that the higher the resistance increase ratio ΔRht, the more likely the element body 102 is to be damaged. Therefore, as in the above-described embodiment, it can be said that it is effective to control the voltage applied to the heating portion 72a such that the rate of increase per unit time of the resistance ratio HR becomes smaller when the resistance increase ratio ΔRht is equal to or greater than the threshold ΔRhtref than when the resistance increase ratio ΔRht is less than the threshold A Rhtref.

What is claimed is:

1. A gas sensor comprising:
a sensor element including an element body and a resistive heating element provided inside the element body; and
a control device configured to control a voltage applied to the resistive heating element,
the gas sensor being configured to detect a concentration of a specific gas in a measurement gas,
wherein the control device is configured to perform heating control processing for controlling the voltage applied to the resistive heating element such that, when a degree of degradation of the resistive heating element is equal to or greater than a predetermined degree, a rate of change per unit time of a resistance-related value related to a resistance value of the resistive heating element is smaller than that when the degree of degradation is less than the predetermined degree, during heating of the element body.

2. The gas sensor according to claim 1,
wherein the resistance-related value is selected from the group consisting of:
a resistance ratio obtained by dividing a current-temperature resistance value, which is a resistance value of the resistive heating element at a current temperature of the sensor element, by a reference-temperature resistance value, which is a resistance value of the resistive heating element at a reference temperature;
a temperature of the element body;
a temperature of any one of a plurality of electrodes provided on the element body; or
an impedance between any two of the plurality of electrodes.

3. The gas sensor according to claim 2,
wherein the control device, during heating of the element body, is configured to set a target heating curve such that, when the degree of degradation is equal to or greater than the predetermined degree, the target heating curve increases more gradually than when the degree of degradation is less than the predetermined degree,
and is configured to control the voltage applied to the resistive heating element such that the resistance ratio increases along the target heating curve.

4. The gas sensor according to claim 2,
wherein the control device, during heating of the element body, is configured to set a target resistance ratio for each time point such that, when the degree of degradation is equal to or greater than the predetermined degree, the target resistance ratio increases more gradually than when the degree of degradation is less than the predetermined degree,
and is configured to control the voltage applied to the resistive heating element such that the resistance ratio increases along the target resistance ratio.

5. The gas sensor according to claim 1,
wherein the degree of degradation is either a resistance increase ratio obtained by dividing a reference-temperature resistance value, which is a resistance value of the resistive heating element at a reference temperature for a current sensor element, by a reference-temperature resistance value for an initial sensor element, or a resistance increase amount obtained by subtracting the reference-temperature resistance value for the initial sensor element from the current reference-temperature resistance value for the current sensor element,
and wherein the control device is configured to determine that the degree of degradation is equal to or greater than the predetermined degree when the resistance increase ratio is equal to or greater than a predetermined increase ratio, or when the resistance increase amount is equal to or greater than a predetermined increase amount.

6. The gas sensor according to claim 5,
wherein the control device, before starting the heating control processing, is configured to estimate the current reference-temperature resistance value of the resistive heating element for the current sensor element based on a resistance value and a temperature of the resistive heating element.

7. The gas sensor according to claim 1,
wherein the element body includes an oxygen-ion-conductive solid electrolyte layer and has, inside, a measurement gas flow path configured to introduce and flow a measurement gas,
the sensor element further includes a pump cell comprising an inner electrode disposed in an internal cavity of the measurement gas flow path and an outer electrode disposed on an outer surface of the element body,
the control device is configured to start pump control processing for controlling the pump cell to pump oxygen out from around the inner electrode to around the outer electrode, or to pump oxygen in from around the outer electrode to around the inner electrode, when the resistance-related value reaches a predetermined resistance-related value during execution of the heating control processing, and
the predetermined resistance-related value is set to be smaller when the degree of degradation is equal to or greater than the predetermined degree than when the degree of degradation is less than the predetermined degree.

8. A control device for use in a gas sensor that comprises a sensor element having an element body and a resistive heating element provided inside the element body, and is configured to detect a concentration of a specific gas in a measurement gas,
wherein the control device is configured to perform heating control processing for controlling a voltage applied to the resistive heating element such that, when a degree of degradation of the resistive heating element is equal to or greater than a predetermined degree, a rate of change per unit time of a resistance-related value related to a resistance value of the resistive heating element is smaller than that when the degree of degradation is less than the predetermined degree, during heating of the element body.

9. A control method for a gas sensor comprising a sensor element having an element body and a resistive heating element provided inside the element body, the gas sensor being configured to detect a concentration of a specific gas in a measurement gas,
the control method comprising performing heating control processing for controlling a voltage applied to the resistive heating element such that, when a degree of degradation of the resistive heating element is equal to or greater than a predetermined degree, a rate of change per unit time of a resistance-related value related to a resistance value of the resistive heating element is smaller than that when the degree of degradation is less than the predetermined degree, during heating of the element body.
